(19) United States
(12) Patent Application Publication
(10) Pub. No.: US 2005/0185781 A1
(43) Pub. Date: Aug. 25, 2005

(54) Method for transferring data

(75) Inventor: Bertolt Eicke, Berlin (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCHAFT, Munchen (DE)

(21) Appl. No.: 11/061,732

(22) Filed: Feb. 22, 2005

(30) Foreign Application Priority Data
Feb. 23, 2004 (DE) 10 2004 009 544.2

(51) Int. Cl. H04M 11/00; H04M 15/00

(52) U.S. Cl. 379/114.17; 379/114.2; 379/114.01

(57) ABSTRACT

A method for transferring data between electronic payment systems, involving a provider payment system associated with a service provider receiving a start message from a provider communication terminal. The provider payment system then uses price data which relate to the service to ascertain a basic price for the service, and the provider payment system asks a memory device for user data which relate to earlier service requests from the service user. The provider payment system uses these user data to ascertain a price which is reduced in comparison with the basic price, and the provider payment system sends a price message which includes the reduced price to a user payment system which is associated with a service user. This prompts the user payment system to check whether an account associated with the service user has an account balance which is needed in order to debit this price.

### CLAIM FOR PRIORITY

This application claims the benefit of priority to German Application No. 10 2004 009 544.2 which was filed in the German language on Feb. 23, 2004, the contents of which are hereby incorporated by reference.

### TECHNICAL FIELD OF THE INVENTION

The invention relates to a method for transferring data between electronic payment systems.

### BACKGROUND OF THE INVENTION

In modern telecommunication networks, telecommunication subscribers are provided with a large number of services.

Examples of such services which may be provided are: the use of supplementary or added-value services (e.g. IN services, IN=Intelligent Network), which go beyond basic voice telephone services, the sending of ringtones for mobile telephones or the purchase of goods or services. To bill for such services, electronic payment systems are used. Electronic payment systems as such are known, for example in mobile radio networks, from the document “3GPP TR 32.815, V 6.0.0, (2003-09), Technical Report, 3rd Generation Partnership Project; Technical Specification Group Services and System Aspects; Telecommunication management; Charging management; Online Charging System (OCS) architecture study”. When such services are provided and used, the case may arise in which a service provider (e.g. a trader) has a different associated payment system than a service user (e.g. a customer).

### SUMMARY OF THE INVENTION

The invention specifies a method for transferring data between electronic payment systems when the service provider and the service user have different associated payment systems.

In one embodiment of the invention, there is a method for transferring data between electronic payment systems, where the method involves a provider payment system associated with a service provider receiving a start message from a provider communication terminal, the provider payment system then using price data which relate to the service to ascertain a basic price for the service, the provider payment system asking a memory device for user data which relate to earlier service requests from the service user, the provider payment system using these user data to ascertain a price which is reduced in comparison with the basic price, and the provider payment system sending a price message which contains the reduced price to a user payment system which is associated with a service user, which prompts the user payment system to check whether an account associated with the service user has an account balance which is needed in order to debit this price. One particular advantage in this case is that the price data and the user data can be provided separately: the price data can be stored in the provider payment system; the user data can be stored in a stand-alone memory device. When required it is necessary to request some of the user data from the user payment system. It is also advantageous that the user payment system is prompted by the price message to check the service user's associated account. This means that it is not necessary for the provider payment system to access the service user's account—which is problematical in terms of the granting of access rights and data integrity.

In another embodiment of the invention, the provider payment system requests the user data from the memory device in the user payment system. The user data are then transferred from the user payment system to the provider payment system. This advantageously allows the user data to be stored in the user payment system—separately from the price data.

The invention may also be in a form such that the method is started upon the appearance of a service request message which is sent from a user communication terminal belonging to a service user to a provider communication terminal belonging to a service provider. This results in a method for transferring data between electronic payment systems, where the method involves a provider payment system associated with the service provider receiving a start message from the provider communication terminal upon the appearance of a service request message which is sent from a user communication terminal belonging to a service user to a provider communication terminal belonging to a service provider, the provider payment system then using price data which relate to the service to ascertain a basic price for the service, the provider payment system asking a user payment system associated with the service user for user data which relate to earlier service requests from the service user, the provider payment system using these user data to ascertain a price which is reduced in comparison with the basic price, and the provider payment system sending a price message which includes the reduced price to the user payment system, which prompts the user payment system to check whether an account associated with the service user has an account balance which is needed in order to debit this price.

In yet another embodiment of the invention, if the account associated with the service user has the account balance which is needed in order to debit the price then the user payment system is prompted by the price message to reserve an account sum corresponding to the price in the account and to send a reservation message to the provider payment system. Such reservation ensures that the appropriate account sum is actually available for later debiting.

Following receipt of the reservation message the provider payment system can send a reservation confirmation message to the provider communication terminal. This informs the provider communication terminal about a successful reservation.

The invention may also proceed in a manner such that if the account associated with the service user has the account balance which is needed in order to debit the price then the user payment system is prompted by the price message to reduce the account balance by a sum corresponding to the price and to send a debit message to the provider payment system. This bills for the service requested by the service user.

Following receipt of the debit message the provider payment system can send a debit confirmation message to the provider communication terminal. This informs the provider communication terminal about the successful debiting of the sum from the account.

The invention may proceed in a manner such that the provider payment system reads the price data relating to the service from a data store in the provider payment system.

The user data can be stored in a memory device in the user payment system. The two variant embodiments of the inventive method which have just been mentioned allow distributed storage of the price and user data: the price data are stored in the provider payment system, and the user data are stored in the user payment system. This makes it a simple matter to meet data protection requirements. This is because the provider communication terminal does not have direct access to the user payment system containing the user data. Similarly, the user communication terminal does not have direct access to the provider payment system containing the price data.

The user payment system can store, as user data, the number of previous times that the service user has used the service, and this number forms at least some of the user data. On the basis of this number of previous times that the service has been used, the provider payment system can ascertain the reduced price, for example by applying a “discount scale”.

In still another embodiment of the invention, following the reduction in the account balance, the user payment system complements the user data with information about the present service use. This updates the user data and adapts them to suit the present service use.

The invention may proceed in a manner such that the user payment system provides the user data with a validity period.

The user payment system can delete the user data when the validity period expires. This firstly allows memory-space-intensive storage of obsolete user data to be avoided, and secondly allows time-dependent discount systems to be implemented.

The user payment system may be arranged in a mobile radio network associated with the service user. The provider payment system may be arranged in a mobile radio network associated with the service provider. This allows the inventive method to be used even when the service user and the service provider use different mobile radio networks and possibly different mobile radio operators are involved.

The invention may also proceed in a manner such that the price message additionally contains information about the present service request, and the user payment system is prompted by the price message to update the user data in line with this information.

### BRIEF DESCRIPTION OF THE INVENTION

The invention is described in detail below with reference to exemplary embodiments illustrated in the figures below, in which:

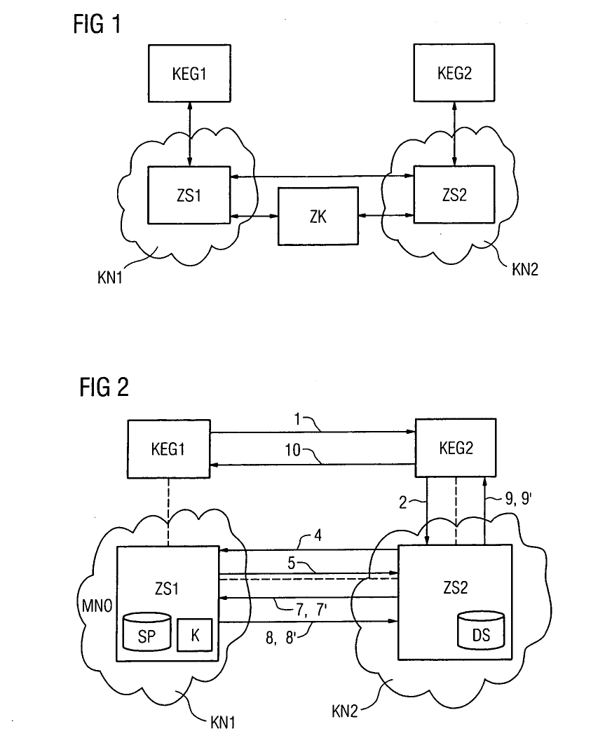

FIG. 1 shows an exemplary embodiment of the interaction between the communication terminals and the payment systems.

FIG. 2 shows an exemplary embodiment of method steps in the invention.

### DETAILED DESCRIPTION OF THE INVENTION

The left-hand side of FIG. 1 shows a user payment system ZS1 which forms part of a first communication network KN1. (Such a user payment system is also called an “issuer”.) In the exemplary embodiment, the first communication network KN1 is a mobile radio network (for example a GPRS or UMTS mobile radio network), which is a mobile radio home network for a service user. This service user (customer) has a user communication terminal KEG1, which is a mobile telephone in the exemplary embodiment. The service user or his user communication terminal has the associated user payment system ZS1, this being symbolized in FIG. 1 by a double-headed arrow.

The right-hand side of FIG. 1 shows a provider payment system ZS2 which forms part of a second communication network KN2. (Such a provider payment system is also called an “acquirer”). Alternatively, the provider payment system ZS2 may form part of the first communication network KN1. In the exemplary embodiment, the second communication network KN2 is a mobile radio network (for example the mobile radio home network) associated with a service provider (dealer, merchant), and it may also be a GPRS or UMTS mobile radio network, for example. In addition, a provider communication terminal KEG2 in the form of a mobile radio module is shown. The service provider or his provider communication terminal KEG2 has the associated provider payment system ZS2. As shown in the bottom part of FIG. 1, the user payment system ZS1 and the provider payment system ZS2 can communicate with one another and can interchange data; this data interchange or this data transfer can take place either directly or via an intermediate node ZK. This intermediate node can also be called a broker node, since it has a broker functionality (i.e. conveys messages between the two payment systems).

FIG. 2 explains an exemplary embodiment of the inventive method. The service user is a mobile telephone customer to whom the mobile radio operator (mobile network operator MNO) in the first communication network KN1 has allocated a prepaid account K (credit account) in the form of an account memory. This prepaid account K is managed by the user payment system ZS1. Using his user communication terminal KEG1, the service user can access the service provider's provider communication terminal KEG2 (for example via the Internet or using the WAP data transfer mechanism known as such, WAP=Wireless Application Protocol). (Alternatively, the service request may be made another way (e.g. not electronically, audibly).) In the exemplary embodiment, this service provider is a weather service provider providing services in the form of weather forecasts. The service provider has used the provider payment system ZS2 to store price data which relates to the price of the services it provides, i.e. the price for the weather forecasts. Such price data are occasionally also called a “rate plan”, and these price data also contain stipulations as to how to reduce a basic price using user data which describe the service user's previous service use behavior.

As soon as the service user wishes to use his user communication terminal KEG1 to retrieve a weather forecast from the service provider, the user communication terminal KEG1 sends a service request message 1 to the provider communication terminal KEG2. This service request message 1 contains an identifier for the user communication terminal KEG1 (for example the mobile radio telephone number MSISDN (MSISDN=Mobile Station ISDN Number), an identifier for the mobile radio operator MNO in the communication network KN1 and information about the requested service (i.e. about the requested weather forecast). (Before the service request message 1 is transmitted, it is optionally possible to check whether prior authentication of the service user has taken place successfully. It is equally possible, as an option, to transmit the service request message anonymously. In the latter case, an anonymous service user number or customer number may be transmitted with the service request message 1 instead of the mobile radio telephone number MSISDN, for example.)

Following receipt of the service request message 1, the provider communication terminal KEG2 sends a start message 2 in the form of a “charging request” to the provider payment system ZS2. The provider payment system ZS2 receives this start message 2 and reads the information about the requested service from the start message. The provider payment system ZS2 then reads price data (relating to the requested service) from a data store DS in the provider payment system ZS2. In the exemplary embodiment, these price data contain the information that the one requested weather forecast costs one euro (1 [symbol] ). This value of one euro represents the basic price for the requested service, and hence the provider payment system has ascertained the basic price for the service (step 3). The provider payment system produces a basic price data record which includes the basic price for the service; the provider payment system has thus ascertained this basic price data record.

The provider payment system ZS2 then asks the user payment system ZS1 for user data which relate to earlier service requests from the service user. In the specific exemplary embodiment, it asks for how frequently in the past the service user has used his user communication terminal KEG1 to request weather forecasts from the service provider. These user data are stored in a memory device SP in the user payment system ZS1. Upon a request message 4, which includes the identifier MSISDN for the user communication terminal KEG1 and an identifier for the provider (e.g. a provider code), the user payment system ZS1 reads the user data from the memory device SP. In the exemplary embodiment, it reads that the service user has already requested weather forecasts from the service provider eight times in the past. In the user payment system ZS1, the user data stored are thus the number of previous times that the service has been used, i.e. the number of previous times that the service user has requested weather forecasts.

The user data are transmitted from the user payment system ZS1 to the provider payment system ZS2 using a challenge-response message 5. The provider payment system ZS2 then uses these user data to reduce the basic price, because the price data for the service use “weather forecast” have an associated stored entry indicating that the basic price will be reduced by 20% after the fifth time that a weather forecast is requested. The provider payment system thus ascertains a reduced price of 0.80 euros (=80% of 1 euro). The provider payment system ZS2 produces a reduced-basic-price data record which includes the price which is reduced as compared with the basic price, and hence the provider payment system ZS2 has ascertained the reduced-basic-price data record. The ascertainment of the basic price for the service using the price data stored in the provider payment system ZS2 is also called “rating”. The ascertainment of the price which is reduced in comparison with the basic price using the user data from the user payment system ZS1 is also called “discounting”.

The provider payment system ZS2 then sends a price message 7 containing the reduced price of 0.80 euros to the user payment system ZS1. This price message 7 thus includes data from the reduced-basic-price data record.

Following receipt of this price message 7, which also includes the service user's identifier MSISDN, the user payment system ZS1 ascertains the service user's prepaid account and checks whether this prepaid account has an account balance which is needed in order to debit this reduced price of 0.80 euros. If this is the case, the user payment system ZS1 reserves an account sum of 0.80 euros in the prepaid account and sends a reservation message 8 to the provider payment system ZS2. This reservation message 8 includes the information that the reservation has been made successfully.

In addition, the price message 7 may also include, as supplementary information, an indication that or of how the user data need to be adapted to suit the present service request. By way of example, a counter (associated with the user) for requested weather forecasts is to be increased by one. The price message 7 may thus include information about the present service request. This price message prompts the user payment system ZS1 to update the user data in line with this information. Following receipt of the price message 7, the user payment system ZS1 changes the user data accordingly, that is to say increases the counter associated with the user, for example, by one.

Upon receipt of the reservation message 8, the provider payment system ZS2 sends a reservation confirmation message 9 to the provider communication terminal KEG2. Following receipt of the reservation confirmation message 9, the provider communication terminal KEG2 provides the service for the service user by using a data message 10 to send the weather forecast from the provider communication terminal KEG2 to the user communication terminal KEG1. The requested service has thus been provided for the service user. The reserved account sum can be debited from the account at a later time.

In a further exemplary embodiment of the inventive method, a modified price message 7′ can prompt the user payment system to reduce the account balance of the prepaid account immediately by the sum of 0.80 euros (i.e. to debit the price for the requested service from the account) and to send a debit message 8′ to the provider payment system ZS2. Following receipt of the debit message 8′, the provider payment system sends a debit confirmation message 9′ to the provider communication terminal KEG2. This then sends the data message 10 containing the weather forecast to the user communication terminal KEG1 in a known manner.

In the two aforementioned exemplary embodiments of the invention, the user payment system ZS1 complements the user data stored in the memory device SP with information about the present service use (e.g. after or at the same time as the debiting has taken place, i.e. after or during the reduction in the account balance of the prepaid account by the 0.80 euros). In this case, the number of weather forecasts retrieved by the user communication terminal KEG1 is increased by one (the present number is thus nine weather forecasts which have already been retrieved), and these user data are stored in the memory device SP in the user payment system ZS1. These user data may also be provided with a validity period. By way of example, the reduced price can be ascertained by taking into account the number of weather forecasts which have been requested within the last twelve months. As soon as a user data item stored in the user data which relates to a requested weather forecast is older than twelve months, this user data item is deleted, since the validity period has expired.

The text below explains a further exemplary embodiment, in which method steps 1, 2 and 3 match the method steps 1, 2 and 3 explained above. In this exemplary embodiment too, the provider payment system has thus ascertained a basic price of 1 euro for the requested weather forecast. The provider payment system ZS2 then uses the request message 4 to request the user data from the user payment system ZS1 and receives, by means of the challenge-response message 5, a transmission including the information that the service user identified by the mobile radio telephone number MSISDN has already purchased ten prepaid weather forecasts for 5 euros beforehand (“group tariff”). This information is stored in the user data in the memory device SP in the user payment system. The provider payment system ZS2 then ascertains a reduced price, which in this case is 0.00 euros (because a group of ten weather forecasts has already been paid for by the service user). The provider payment system ZS2 then sends the price message 7 for 0.00 euros to the user payment system ZS1. This price message 7 additionally includes the information that a weather forecast will be delivered to the service user. The user payment system then complements the user data with information about the present service use, i.e. the user data are used to store the fact that one weather forecast from the ten prepaid weather forecasts has been delivered to the service user. This means that the service user can now have nine prepaid weather forecasts at a later time. The weather forecast is then transmitted from the provider communication terminal to the user communication terminal KEG1 in a known manner.

In the exemplary embodiments cited, the user data can be stored in the memory device SP in the user payment system ZS1 using or in the form of counters (usage counters). A counter of this type is incremented (in this case the counter counts the services which have already been provided, e.g. directly as a number of times that the service is provided or else converted into bonus points or status points, for example into bonus points in an airmile system) or decremented (in this case the counter stores the number of service requests which have already been prepaid) when service requests appear or when the requested service is provided.

The actual monetary cash settlement between the service user and the service provider is made (e.g. via the operators of the payment system involved or else additionally via a broker) at a later time in conventional fashion, e.g. by means of bank transfer or by debiting from a bank account associated with the service user.

A particular advantage of the method described for transferring data between electronic payment systems is that storing the user data in the user payment system and storing the price data in the provider payment system separates the data, which can be used to take into account the data protection requirements both of the service user and of the service provider. This method allows the service user to remain anonymous to the service provider and also to the latter's provider payment system. It is nevertheless possible to provide attractive pricing for the customer, however, since it is possible to take into account his earlier service use behavior in the form of the user data for ascertaining the reduced price. In addition, the inventive method allows the service provider to remain anonymous to the service user and to the user payment system ZS1. The invention may advantageously be carried out even when the provider payment system ZS2 and the user payment system ZS1 are arranged in different mobile radio networks. This means that the provider payment system ZS2 can be arranged in the home mobile radio network of the service provider and the user payment system ZS1 can be arranged in the home mobile radio network of the service user. The user payment system ZS1 can therefore access a prepaid account belonging to the service user which (account) already exists and is arranged in the user's home mobile radio network.

1. A method for transferring data between electronic payment systems, comprising:
receiving, at a provider payment system associated with a service provider, a start message from a provider communication terminal, the provider payment system using price data which relates to the service to ascertain a basic price for the service;
asking a memory device (SP) for user data which relate to earlier service requests from the service user, the provider payment system using the user data to ascertain a price which is reduced in comparison with the basic price; and
sending a price message which includes the reduced price to a user payment system which is associated with a service user, which prompts the user payment system to check whether an account associated with the service user has an account balance which is used to debit the price.

2. The method as claimed in claim 1, wherein the provider payment system requests the user data from the memory device in the user payment system.

3. The method as claimed in claim 1, wherein the method is started upon an appearance of a service request message which is sent from a user communication terminal belonging to a service user to a provider communication terminal belonging to a service provider.

4. The method as claimed in claim 1, wherein if the account associated with the service user has the account balance used to debit the price, then the user payment system is prompted by the price message to reserve an account sum corresponding to the price in the account and to send a reservation message to the provider payment system.

5. The method as claimed in claim 4, wherein following receipt of the reservation message, the provider payment system sends a reservation confirmation message to the provider communication terminal.

6. The method as claimed in claim 1, wherein if the account associated with the service user has the account balance which used to debit the price, then the user payment system is prompted by the price message to reduce the account balance by a sum corresponding to the price and to send a debit message to the provider payment system.

7. The method as claimed in claim 6, wherein following receipt of the debit message the provider payment system sends a debit confirmation message to the provider communication terminal.

8. The method as claimed in claim 1, wherein the provider payment system reads the price data relating to the service from a data store in the provider payment system.

9. The method as claimed in claim 1, wherein the user data are stored in a memory device in the user payment system.

10. The method as claimed in claim 1, wherein the user payment system stores, as user data, a number of previous times that the service user has used the service.

11. The method as claimed in claim 10, wherein following the reduction in the account balance, the user payment system complements the user data with information about the present service use.

12. The method as claimed in claim 1, wherein the user payment system provides the user data with a validity period.

13. The method as claimed in claim 12, wherein the user payment system deletes the user data when the validity period expires.

14. The method as claimed in claim 1, wherein the user payment system is arranged in a mobile radio network associated with the service user.

15. The method as claimed in claim 1, wherein the provider payment system is arranged in a mobile radio network associated with the service provider.

16. The method as claimed in claim 1, wherein the price message includes information about the present service request, and the user payment system is prompted by the price message to update the user data in line with the information.
